(19) United States
(12) Patent Application Publication
(10) Pub. No.: US 2021/0089603 A1
(43) Pub. Date: Mar. 25, 2021

(54) STACKING MODEL FOR RECOMMENDATIONS

(71) Applicant: Microsoft Technology Licensing, LLC, Redmond, WA (US)

(72) Inventor: Samaneh Abbasi Moghaddam, Santa Clara, CA (US)

(73) Assignee: Microsoft Technology Licensing, LLC, Redmond, WA (US)

(21) Appl. No.: 16/577,129

(22) Filed: Sep. 20, 2019

(51) Int. Cl. G06F 16/9536; G06N 20/00; G06K 9/62; G06F 16/9535

(52) U.S. Cl. CPC G06F 16/9536; G06F 16/9535; G06K 9/6282; G06N 20/00

(57) ABSTRACT

The disclosed embodiments provide a system for processing data. During operation, the system determines, based on data retrieved from a data store in an online system, features related to a user of the online system and an entity. Next, the system applies, to the features, a tree-based model that predicts outcomes between users and entities to generate a set of values representing interactions among the features. The system then inputs the set of values into a machine learning model to produce a score representing a likelihood of an outcome between the user and the entity. Finally, the system outputs a recommendation related to the user and the entity based on the score.

### BACKGROUND

### Field

The disclosed embodiments relate to machine learning models for recommendations. More specifically, the disclosed embodiments relate to a stacking model for recommendations.

### Related Art

Analytics is commonly used to discover trends, patterns, relationships, and/or other attributes related to large sets of complex, interconnected, and/or multidimensional data. In turn, the discovered information is used to derive insights and/or guide decisions or actions related to the data. For example, business analytics may be used to assess past performance, guide business planning, and/or identify actions that may improve future performance.

To glean such insights, large datasets of features are analyzed using regression models, artificial neural networks, support vector machines, decision trees, naïve Bayes classifiers, and/or other types of machine learning models. The discovered information can then be used to guide decisions and/or perform actions related to the data. For example, the output of a machine learning model is used to guide marketing decisions, assess risk, detect fraud, predict behavior, and/or customize or optimize use of an application or website.

However, significant time, effort, and overhead is spent on feature selection during creation and training of machine-learning models for analytics. For example, a dataset for a machine-learning model may have thousands to millions of features, including features that are created from combinations of other features, while only a fraction of the features and/or combinations may be relevant and/or important to the machine-learning model. At the same time, training and/or execution of machine-learning models with large numbers of features and/or large datasets typically require more memory, computational resources, and time than those of machine-learning models with smaller numbers of features and/or smaller datasets. Excessively complex machine-learning models that utilize too many features may additionally be at risk for overfitting.

Consequently, machine learning and/or analytics may be facilitated by mechanisms for improving the creation, profiling, management, sharing, selection, and reuse of features and/or machine learning models.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for selecting recommendations. For example, the recommendations include jobs that are customized to users who browse and/or search for job postings, users identified as job seekers, and/or other types of candidates and potential candidates for jobs. Such jobs can further be matched to the candidates' education, work experience, skills, level of seniority, location, current titles, and/or past titles.

More specifically, the disclosed embodiments provide a method, apparatus, and system for using a stacking model to generate and/or select jobs (or other entities) as recommendations to users. The stacking model includes a tree-based model that is trained to predict outcomes between pairs of users and jobs, based on features for the users and/or jobs. For example, the tree-based model includes a gradient boosted tree that learns to predict positive and/or negative outcomes between user-job pairs, based on features such as attributes of the users, attributes of the jobs, and/or similarities between the attributes of the users and corresponding attributes of the jobs. As a result, individual paths from root to leaf nodes of the tree-based model represent interactions among features that appear in the paths.

The stacking model also includes a machine learning model that is applied to values of the interactions outputted by the tree-based model to predict outcomes between new pairs of users and jobs. For example, the machine learning model includes one or more regression models, artificial neural networks, support vector machines, naïve Bayes classifiers, Bayesian networks, deep learning models, hierarchical models, and/or ensemble models. Features associated with the machine learning model include values outputted by leaf nodes of the tree-based model, after attributes for a given user and job and/or similarities between the attributes of the user and corresponding attributes of the job are inputted into the tree-based model. In turn, the machine learning model processes the features to output a score representing the likelihood of a positive outcome between the user and job, such as the user clicking on, viewing over multiple sessions, and/or applying to the job.

The output of the machine learning model is additionally used to generate recommendations related to user-job pairs. For example, the machine learning model is used to generate scores between a user and a set of jobs, and the jobs are ranked by descending score. A highest-ranked portion of the jobs is then outputted as recommendations to the user in one or more emails, notifications, messages, search results, and/or other mechanisms for interacting or communicating with the user.

By training a first tree-based model to predict outcomes between users and jobs (or other entities) based on features for the users and jobs, the disclosed embodiments transform the features into a smaller set of “feature interactions” that are used to predict the outcomes. The interactions can then be inputted into a second machine learning model that is used to generate recommendations and/or other output related to the users and jobs. The second machine learning model is thus able to execute with higher performance and/or lower latency, computational overhead, and/or memory consumption than a conventional technique that applies a machine learning model to the full set of untransformed features. Consequently, the disclosed embodiments improve computer systems, applications, user experiences, tools, and/or technologies related to user recommendations, training and executing machine learning models, feature engineering, employment, recruiting, and/or hiring.

### Stacking Model for Recommendations

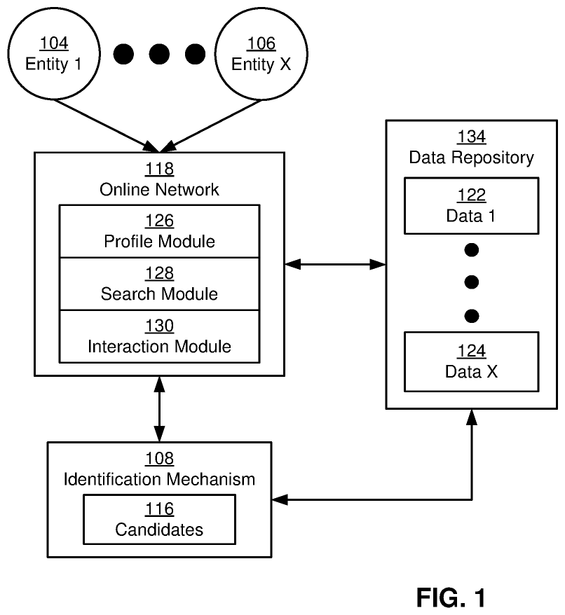

FIG. 1 shows a schematic of a system in accordance with the disclosed embodiments. As shown in FIG. 1, the system includes an online network 118 and/or other user community. For example, online network 118 includes an online professional network that is used by a set of entities (e.g., entity 1 104, entity x 106) to interact with one another in a professional and/or business context.

The entities include users that use online network 118 to establish and maintain professional connections, list work and community experience, endorse and/or recommend one another, search and apply for jobs, and/or perform other actions. The entities also, or instead, include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 also allows the entities to view the profiles of other entities in online network 118.

Profile module 126 also, or instead, includes mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 is tracked and stored in a database, data warehouse, cloud storage, and/or other data-storage mechanism providing data repository 134.

Data in data repository 134 is then used to generate recommendations and/or other insights related to listings of jobs or opportunities within online network 118. For example, one or more components of online network 118 may track searches, clicks, views, text input, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend jobs, advertisements, posts, articles, connections, products, companies, groups, and/or other types of content, entities, or actions to members of online network 118.

More specifically, data in data repository 134 and one or more machine learning models are used to produce rankings of candidates associated with jobs or opportunities listed within or outside online network 118. As shown in FIG. 1, an identification mechanism 108 identifies candidates 116 associated with the opportunities. For example, identification mechanism 108 may identify candidates 116 as users who have viewed, searched for, and/or applied to jobs, positions, roles, and/or opportunities, within or outside online network 118. Identification mechanism 108 may also, or instead, identify candidates 116 as users and/or members of online network 118 with skills, work experience, and/or other attributes or qualifications that match the corresponding jobs, positions, roles, and/or opportunities.

After candidates 116 are identified, profile and/or activity data of candidates 116 are inputted into the machine learning model(s), along with features and/or characteristics of the corresponding opportunities (e.g., required or desired skills, education, experience, industry, title, etc.). In turn, the machine learning model(s) output scores representing the strengths of candidates 116 with respect to the opportunities and/or qualifications related to the opportunities (e.g., skills, current position, previous positions, overall qualifications, etc.). For example, the machine learning model(s) generate scores based on similarities between the candidates' profile data with online network 118 and descriptions of the opportunities. The model(s) further adjust the scores based on social and/or other validation of the candidates' profile data (e.g., endorsements of skills, recommendations, accomplishments, awards, patents, publications, reputation scores, etc.). The rankings are then generated by ordering candidates 116 by descending score.

In turn, rankings based on the scores and/or associated insights improve the quality of candidates 116, recommendations of opportunities to candidates 116, and/or recommendations of candidates 116 for opportunities. Such rankings may also, or instead, increase user activity with online network 118 and/or guide the decisions of candidates 116 and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, the component(s) may output a ranking of candidates for a given set of job qualifications as search results to a recruiter after the recruiter performs a search with the job qualifications included as parameters of the search. In a fourth example, the component(s) may recommend jobs to a candidate based on the predicted relevance or attractiveness of the jobs to the candidate and/or the candidate's likelihood of applying to the jobs.

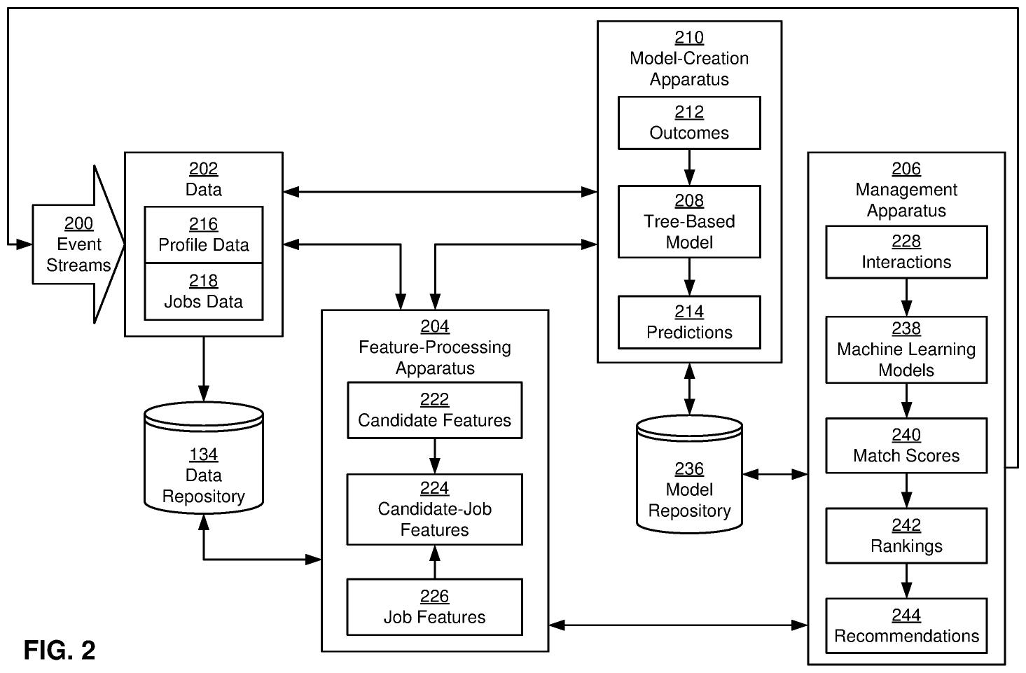

In one or more embodiments, online network 118 includes functionality to improve the timeliness, relevance, and/or accuracy of recommendations related to candidates and/or opportunities. As shown in FIG. 2, data repository 134 and/or another primary data store may be queried for data 202 that includes profile data 216 for members of an online network (e.g., online network 118 of FIG. 1), as well as jobs data 218 for jobs that are listed or described within or outside the online network.

Profile data 216 includes data associated with member profiles in the online network. For example, profile data 216 for an online professional network includes a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. Profile data 216 also, or instead, includes a set of groups to which the user belongs, the user's contacts and/or connections, and/or other data related to the user's interaction with the online network.

Attributes of the members from profile data 216 are optionally matched to a number of member segments, with each member segment containing a group of members that share one or more common attributes. For example, member segments in the online network may be defined to include members with the same industry, title, location, and/or language.

Connection information in profile data 216 is optionally combined into a graph, with nodes in the graph representing entities (e.g., users, schools, companies, locations, etc.) in the online network. Edges between the nodes in the graph represent relationships between the corresponding entities, such as connections between pairs of members, education of members at schools, employment of members at companies, following of a member or company by another member, business relationships and/or partnerships between organizations, and/or residence of members at locations.

Jobs data 218 includes structured and/or unstructured data for job listings and/or job descriptions that are posted and/or provided by members of the online network. For example, jobs data 218 for a given job or job listing may include a declared or inferred title, company, required or desired skills, responsibilities, qualifications, role, location, industry, seniority, salary range, benefits, and/or member segment.

In one or more embodiments, data repository 134 stores data that represents standardized, organized, and/or classified attributes in profile data 216 and/or jobs data 218. For example, skills in profile data 216 and/or jobs data 218 are organized into a hierarchical taxonomy that is stored in data repository 134 and/or another repository. The taxonomy models relationships between skills (e.g., “Java programming” is related to or a subset of “software engineering”) and/or standardize identical or highly related skills (e.g., “Java programming,” “Java development,” “Android development,” and “Java programming language” are standardized to “Java”).

In another example, locations in data repository 134 include cities, metropolitan areas, states, countries, continents, and/or other standardized geographical regions. Like standardized skills, the locations can be organized into a hierarchical taxonomy (e.g., cities are organized under states, which are organized under countries, which are organized under continents, etc.).

In a third example, data repository 134 includes standardized company names for a set of known and/or verified companies associated with the members and/or jobs. In a fourth example, data repository 134 includes standardized titles, seniorities, and/or industries for various jobs, members, and/or companies in the online network. In a fifth example, data repository 134 includes standardized time periods (e.g., daily, weekly, monthly, quarterly, yearly, etc.) that can be used to retrieve profile data 216, user activity 218, and/or other data 202 that is represented by the time periods (e.g., starting a job in a given month or year, graduating from university within a five-year span, job listings posted within a two-week period, etc.). In a sixth example, data repository 134 includes standardized job functions such as “accounting,” “consulting,” “education,” “engineering,” “finance,” “healthcare services,” “information technology,” “legal,” “operations,” “real estate,” “research,” and/or “sales.”

In some embodiments, standardized attributes in data repository 134 are represented by unique identifiers (IDs) in the corresponding taxonomies. For example, each standardized skill is represented by a numeric skill ID in data repository 134, each standardized title is represented by a numeric title ID in data repository 134, each standardized location is represented by a numeric location ID in data repository 134, and/or each standardized company name (e.g., for companies that exceed a certain size and/or level of exposure in the online system) is represented by a numeric company ID in data repository 134.

Data 202 in data repository 134 can be updated using records of recent activity received over one or more event streams 200. For example, event streams 200 are generated and/or maintained using a distributed streaming platform such as Apache Kafka (Kafka™ is a registered trademark of the Apache Software Foundation). One or more event streams 200 are also, or instead, provided by a change data capture (CDC) pipeline that propagates changes to data 202 from a source of truth for data 202. For example, an event containing a record of a recent profile update, job search, job view, job application, response to a job application, connection invitation, post, like, comment, share, and/or other recent member activity within or outside the platform is generated in response to the activity. The record is then propagated to components subscribing to event streams 200 on a nearline basis.

A feature-processing apparatus 204 uses data 202 from event streams 200 and/or data repository 134 to calculate sets of features for users and/or entities in the online network. In some embodiments, the users include candidates (e.g., candidates 116 of FIG. 1) for opportunities, and the entities include jobs and/or other types of opportunities. In one or more embodiments, feature-processing apparatus 204 includes functionality to execute on an offline, periodic, and/or batch-processing basis to produce features for a large number of candidates and/or candidate-job pairs (e.g., combinations of members in the community and jobs for which the members are qualified). Feature-processing apparatus 204 also, or instead, generates features in an online, nearline, and/or on-demand basis based on recent job-seeking activity by a candidate (e.g., a user session with the online network, a job search, a job view, a click on a job, an application for a job, etc.).

In one or more embodiments, feature-processing apparatus 204 generates and/or obtains candidate features 222, job features 226, and candidate-job features 224 for a given candidate-job pair (or another grouping of one or more candidates and/or one or more jobs). Candidate features 222 include attributes of the candidate, and job features 226 include features of the job. For example, candidate features 222 include, but are not limited to, the candidate's current and/or past title, function, skills, education (e.g., degree, field of study, school, etc.), past company, company size, seniority, amount of experience (e.g., number of days, months, or years in the candidate's career history), industry, location, language, and/or other professional and/or demographic attributes. Similarly, job features 226 include, but are not limited to, the job's title, industry, function, company, company size, seniority, desired or required skill and experience, salary range, and/or location.

Candidate-job features 224 include similarities, statistics, and/or other combinations, aggregations, scaling, and/or transformations of the candidate's and/or job's attributes. For example, candidate-job features 224 include cosine similarities, Hadamard products, Jaccard similarities/distances, cross products, Euclidean distances, and/or other measures of similarity, distance, or overlap between standardized versions of all of the candidate's attributes and all of the job's corresponding attributes. Candidate-job features 224 also, or instead, include measures of similarity or overlap between text in the candidate's profile and the description or posting of the job. Candidate-job features 224 also, or instead, include other measures of similarity and/or compatibility between one attribute of the candidate and another attribute of the job (e.g., a match percentage between a candidate's “Java” skill and a job's “C++” skill).

In one or more embodiments, candidate-job features 224 include comparisons of candidate features 222 and job features 226 at different levels of granularity. For example, locations in candidate features 222 and job features 226 include the city, state, country, and region of the candidate and the job, respectively. As a result, candidate-job features 224 capture the “levels” on which the candidate's location matches the job's location. In another example, titles in candidate features 222 and job features 226 can be compared for similarity or overlap along multiple dimensions. Thus, two titles of “Java Software Engineer” and “Software Engineering Manager” can be compared for similarity or overlap in individual tokens (e.g., overlap or similarity in the “Software” and “Engineer” tokens), roles (e.g., “Engineer” versus “Manager”), specialties (e.g., “Java” versus “Software Engineering”), and/or seniority (e.g., “Senior” versus “Manager”).

In one or more embodiments, candidate features 222, job features 226, and candidate-job features 224 are generated for candidate-job pairs with prior history and/or known outcomes. For example, feature-processing apparatus 204 and/or another component obtain and/or generate features for a set of candidate-job pairs, with each candidate-job pair containing a job and a candidate that was shown the job as a recommendation, search result, and/or in another context.

After candidate features 222, job features 226, and candidate-job features 224 are calculated for one or more candidate-job pairs, feature-processing apparatus 204 stores the features in data repository 134 for subsequent retrieval and use. Feature-processing apparatus 204 also, or instead, provides the features to a model-creation apparatus 210, a management apparatus 206, and/or another component of the system for use in generating recommendations 244 and/or other output related to the candidates and jobs.

Model-creation apparatus 210 trains and/or updates a tree-based model 208 using sets of features from feature-processing apparatus 204, outcomes 212 associated with the feature sets and/or corresponding candidate-job pairs, and predictions 214 produced by tree-based model 208 from the feature sets. In some embodiments, outcomes 212 include positive and/or negative outcomes between the candidates and jobs, after the jobs have been shown as recommendations 244 and/or other types of output to the candidates. For example, positive outcomes 212 between a candidate and a job include, but are not limited to, the candidate clicking on the job, viewing the job multiple times (e.g., over multiple sessions), saving the job, applying to the job, receiving an offer for the job, and/or accepting the offer. Negative outcomes 212 between the candidate and job include, but are not limited to, the candidate ignoring the job and/or dismissing the job.

More specifically, model-creation apparatus 210 trains tree-based model 208 to generate predictions 214 representing the likelihoods of different types of outcomes 212 for each candidate-job pair, given the candidate's impression of a listing, description, or recommendation of the job. For example, model-creation apparatus 210 inputs candidate features 222, job features 226, and candidate-job features 224 for candidate-job pairs with known outcomes 212 into a gradient boosted tree. Model-creation apparatus 210 then uses a training technique and/or one or more hyperparameters to update parameters values of the gradient boosted tree so that predictions 214 outputted by the gradient boosted tree better reflect outcomes 212 for the corresponding candidate-job pairs.

In turn, interactions 228 among candidate features 222, job features 226, and candidate-job features 224 are captured along paths from root to leaf nodes of one or more trees in the trained tree-based model 208. Continuing with the above example, the trained gradient boosted tree includes around 100 decision trees with a relatively shallow depth (e.g., 3-4 nodes). Each path from a root node of a decision tree in the gradient boosted tree to a leaf node of the decision tree represents an interaction among features in the path, since the condition or state of a child node is dependent on the condition or state of the corresponding parent node. Moreover, the value outputted by the leaf node represents an aggregation or encoding of the features used in the path. In other words, the gradient boosted tree transforms thousands or tens of thousands of candidate features 222, job features 226, and candidate-job features 224 into hundreds of interactions represented by root-to-leaf paths in the gradient boosted tree.

After tree-based model 208 is created and/or updated, model-creation apparatus 210 stores parameters of tree-based model 208 in a model repository 236. For example, model-creation apparatus 210 may replace old values of the parameters in model repository 236 with the updated parameters, or model-creation apparatus 210 may store the updated parameters separately from the old values (e.g., by storing each set of parameters with a different version number of tree-based model 208).

In some embodiments, management apparatus 206 obtains a representation of tree-based model 208 from model-creation apparatus 210, model repository 236, and/or another source. Next, management apparatus 206 applies tree-based model 208 to additional candidate features 222, job features 226, and candidate-job features 224 for a given candidate and a set of jobs to calculate values of interactions 228 among the features. For example, management apparatus 206 inputs the features into tree-based model 208 and obtains interactions 228 as values of some or all leaf nodes in tree-based model 208.

Management apparatus 206 then inputs values of interactions 228 into one or more additional machine learning models 238. In one or more embodiments, machine learning models 238 generate output related to the compatibility of the candidate with the jobs. For example, machine learning models 238 are trained by model-creation apparatus 210 and/or another component of the system to predict one or more types of positive outcomes between candidates and jobs, given interactions 228 among features for the candidates and jobs produced by tree-based model. After machine learning models 238 are trained, machine learning models 238 generate match scores 240 ranging from 0 to 1. Each match score represents the likelihood of a positive outcome between a candidate and a job. The positive outcome includes, but is not limited to, the candidate applying to the job, given the candidate's impression of the job; the candidate receiving a response to the job application; adding of the candidate to a hiring pipeline for the job; interviewing of the candidate for the job; and/or hiring of the candidate for the job. As with the generation of features inputted into tree-based model 208 and/or machine learning models 238, match scores 240 may be produced in an offline, batch-processing, and/or periodic basis (e.g., from batches of features), or match scores 240 may be generated in an online, nearline, and/or on-demand basis (e.g., when the candidate logs in to the online network, views a job, performs a job search, applies for a job, and/or performs another action).

In one or more embodiments, machine learning models 238 include a global version, a set of personalized versions, and a set of job-specific versions. The global version includes a single machine learning model that tracks the behavior or preferences of all candidates with respect to all jobs in data repository 134. Each personalized version of the model is customized to the individual behavior or preferences of a corresponding candidate with respect to certain job features (e.g., a candidate's personal preference for jobs that match the candidate's skills). Each job-specific model identifies the relevance or attraction of a corresponding job to certain candidate features (e.g., a job's likelihood of attracting candidates that prefer skill matches).

The output of the global version, a personalized version for the candidate, and/or a job-specific version for a given job are combined to generate a match score (e.g., match scores 240) representing the predicted probability of the candidate applying to the job, clicking on the job, and/or otherwise responding positively to an impression or recommendation of the job. For example, a generalized linear mixed model for predicting the probability of member m applying to job j using logistic regression is represented using the following equation:

g(E[yₘⱼₜ])=x′ₘⱼₜb+s′ⱼαₘ+q′ₘβⱼ,

where

$$g ( E [ {y}_{mjt} ] ) = log \frac{E [ {y}_{mjt} ]}{1 - E [ {y}_{mjt} ]}$$

is the link function for the model, b is the coefficient vector representing the fixed effects of the global version of the model, αₘ is a coefficient vector representing the random effects of a user-specific version of the model for member m, and βⱼ is a coefficient vector representing the random effects of a job-specific version of the model for job j. In addition, xₘⱼₜ represents the feature vector for the global version, which contains member features of member m, job features of job j, derived features, and/or features associated with context t. Finally, sⱼ represents the feature vector of job j (i.e., job features 226), and qₘ represents the feature vector of member m (i.e., candidate features 222). In other words, scores generated by the global version, personalized version, and job-specific version are aggregated into a sum and/or weighted sum that is used as the candidate's predicted probability of responding positively to the job after viewing the job.

When a member m has provided multiple responses to different jobs, the member's personalized coefficient vector αₘ can be accurately estimated, and scores and/or recommendations can be personalized to the member. Conversely, when member m lacks previous responses to jobs, the posterior mean of αₘ is close to 0, and the output of the model falls back to the global fixed effects component of x′ₘⱼₜb. Similarly, when a job j includes multiple responses by members, the job's personalized coefficient vector βⱼ can be used to adapt the output of the model with respect to the job. On the other hand, a lack of responses to the job causes the posterior mean of βⱼ to be close to 0, and the global version contributes overwhelmingly to the score between the job and a given member.

In one or more embodiments, interactions 228 are inputted into the global version of machine learning models 238, resulting in “stacking” of the global version on top of the output of tree-based model 208. For example, management apparatus 206 concatenates values of leaf nodes from tree-based model 208 into a vector. Next, management apparatus 206 inputs the vector, along with optional candidate features 222, job features 226, and/or candidate-job features 224, into the global version. Management apparatus 206 also inputs one or more candidate features 222 into the job-specific model for the job pair and one or more job features 226 into the user-specific model for the candidate. Management apparatus 206 then combines the output of the global version, job-specific model, and user-specific version into a match score between the candidate and job.

After match scores 240 are produced between the candidate and a set of jobs (e.g., jobs that match the candidate's search parameters and/or one or more attributes of the candidate), management apparatus generates rankings 242 of the jobs by the corresponding match scores 240. For example, management apparatus 206 may rank the jobs for the candidate by descending predicted likelihood of positively responding to the jobs.

Finally, management apparatus 206 outputs some or all jobs in rankings 242 as recommendations 244 to the candidate. In some embodiments, management apparatus 206 generates recommendations 244 as search results of the candidate's job search, search results of a recruiter's search for qualified candidates for a job, job recommendations that are displayed and/or transmitted to the candidate, and/or within other contexts related to job seeking, recruiting, careers, and/or hiring. For example, management apparatus 206 displays some or all filtered jobs 228 that have been ranked by descending match scores 240 from machine learning models 238 within a job search tool, email, notification, message, and/or another communication containing job recommendations 244 to the candidate. Subsequent responses to recommendations 244 may, in turn, be used to generate events that are fed back into the system and used to update features, tree-based model 208, machine learning models 238, and/or recommendations 244.

By training a first tree-based model 208 to predict outcomes between users and jobs (or other entities) based on features for the users and jobs, the disclosed embodiments transform the features into a smaller set of feature interactions 228. Interactions 228 can then be inputted into one or more additional machine learning models 238 that generate recommendations 244 and/or other output related to the users and jobs. In turn, machine learning models 238 are able to execute with higher performance and/or lower latency, computational overhead, and/or memory consumption than a conventional technique that applies a machine learning model to the full set of untransformed features. Consequently, the disclosed embodiments improve computer systems, applications, user experiences, tools, and/or technologies related to user recommendations, training and executing machine learning models, feature engineering, employment, recruiting, and/or hiring.

Those skilled in the art will appreciate that the system of FIG. 2 may be implemented in a variety of ways. First, feature-processing apparatus 204, model-creation apparatus 210, management apparatus 206, data repository 134, and/or model repository 236 may be provided by a single physical machine, multiple computer systems, one or more virtual machines, a grid, one or more databases, one or more filesystems, and/or a cloud computing system. Feature-processing apparatus 204, model-creation apparatus 210, and management apparatus 206 may additionally be implemented together and/or separately by one or more hardware and/or software components and/or layers.

Second, a number of models and/or techniques may be used to determine and/or generate interactions 228, match scores 240, and/or rankings 242. For example, the functionality of tree-based model 208 and/or machine learning models 238 may be provided by regression models, artificial neural networks, support vector machines, decision trees, random forests, gradient boosted trees, naïve Bayes classifiers, Bayesian networks, clustering techniques, collaborative filtering techniques, deep learning models, hierarchical models, and/or ensemble models. In another example, management apparatus 206 obtains interactions 228 as values of one or more hidden layers in a neural network or deep learning model that predicts outcomes 212 for candidate-job pairs based on the corresponding candidate features 222, job features 226, and/or candidate-job features 224. These interactions 228 can be combined with interactions 228 learned by tree-based model 208 as input into machine learning models 238 or inputted into machine learning models 238 in lieu of interactions 228 learned by tree-based model 208. In a third example, management apparatus 206 uses the output of tree-based model 208 to generate match scores 240 for candidate-job pairs, in lieu of or in addition to the output of machine learning models 238. In a fourth example, management apparatus 206 inputs some or all interactions 228 into multiple machine learning models 238 related to a candidate and job (e.g., global, job-specific, user-specific, etc.) and combines the output of machine learning models 238 into a match score between the candidate and job. In a fifth example, multiple levels and/or groupings of models are stacked and/or combined to form an ensemble model that generates match scores 240 and/or recommendations 244 from one or more sets of features.

The retraining or execution of tree-based model 208 and/or machine learning models 238 may also be performed on an offline, online, and/or on-demand basis to accommodate requirements or limitations associated with the processing, performance, or scalability of the system and/or the availability of features used to train each model. Multiple versions of tree-based model 208 and/or one or more machine learning model 238 may further be adapted to different subsets of candidates and/or jobs, or the same tree-based model 208 and/or machine learning model may be used to generate interactions 228 and/or match scores 240 for all candidates and/or jobs.

Third, the system of FIG. 2 may be adapted to different types of candidates, opportunities, features, and/or recommendations 244. For example, tree-based model 208 and machine learning models 238 may be used to generate interactions 228, match scores 240, rankings 242, and/or recommendations 244 related to awards, publications, patents, group memberships, profile summaries, academic positions, artistic or musical roles, fields of study, fellowships, scholarships, competitions, hobbies, online dating matches, goods, services, movies, and/or other entities that can matched to user behavior and/or preferences.

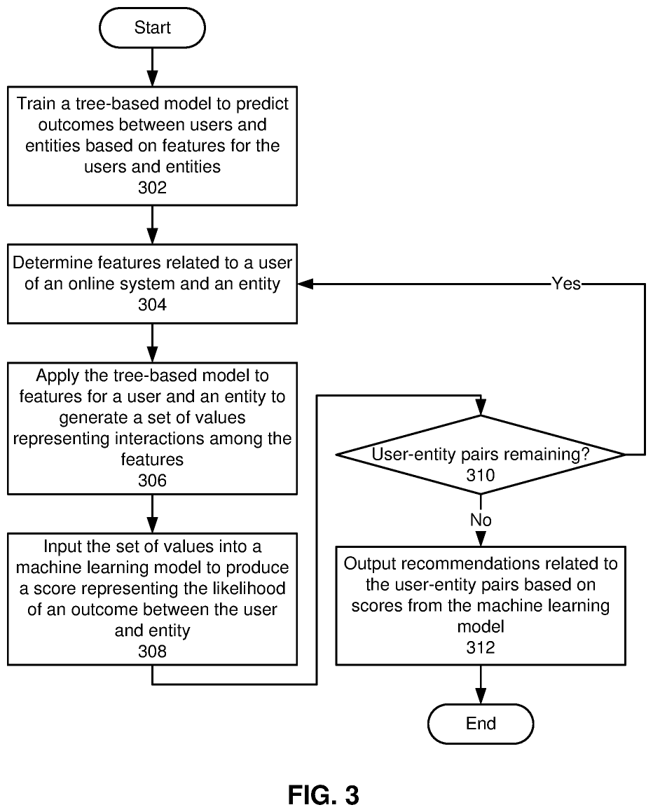

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a tree-based model is trained to predict outcomes between users and entities based on features for the users and entities (operation 302). In some embodiments, the entities include content, goods, services, organizations, locales, actions, other users, and/or other items that can be recommended to the users based on attributes related to the users and/or entities.

For example, the tree-based model includes a gradient boosted tree, random forest, and/or another ensemble of decision trees that predicts positive and/or negative outcomes between users and jobs. The positive outcomes include, but are not limited to, clicks, impressions (e.g., over multiple sessions), and/or applications to the jobs by the candidates and/or hiring of the candidates for the jobs. The negative outcomes include, but are not limited to, ignores and dismisses of the jobs by the candidates. Features inputted into the tree-based model include, but are not limited to, user features generated from attributes of the users and job features generated from corresponding attributes of the jobs. The user and job attributes include, but are not limited to, titles, seniorities, industries, functions, languages, company sizes, degrees, fields of study, skills, and/or locations of the users and jobs. The features also, or instead, include user-job features that capture comparisons, similarities, or overlap (e.g., cosine similarities, Hadamard products, cross products, etc.) between individual candidates and individual jobs. After the tree-based model is fit to training data that includes the features and outcomes, interactions among the features are captured by paths from root to leaf nodes in the tree-based model.

Next, features related to a user of an online system and an entity are determined (operation 304), and the tree-based model is applied to features for a user and an entity to generate a set of values representing interactions among the features (operation 306). Continuing with the above example, attributes of the user and job are retrieved from a data store in the online system (e.g., online network 118 of FIG. 1), and user features for the user, job features for the job, and user-job features between the user and job are generated. The features are inputted into the tree-based model, and interactions among the features are obtained as predictions and/or other output from leaf nodes of the tree-based model.

The set of values is then inputted into a machine learning model to produce a score representing the likelihood of an outcome between the user and entity (operation 308). Continuing with the above example, output from the leaf nodes of the tree-based model is concatenated into a vector that is inputted into one or more versions of the machine learning model (e.g., global, user-specific, and/or job-specific versions in a generalized linear mixed model). Additional features related to the user and/or job are optionally inputted into each version of the machine learning model. Output from the versions is then combined using a sum, weighted sum, and/or other type of aggregation into a score representing the likelihood of a positive outcome between the user and job. As a result, the tree-based model and machine learning model form a stacking model that reduces the number and complexity of features inputted into the machine learning model and/or improves the latency, performance, and/or accuracy of the machine learning model.

Operations 304-308 may be repeated for remaining user-entity pairs (operation 310). For example, the tree-based model may be used to generate interactions among features for the same user and multiple jobs (or other entities), the same job (or entity) and multiple users, and/or other pairwise combinations of users and jobs (or other types of entities).

Finally, recommendations related to the user-entity pairs are outputted based on scores from the machine learning model (operation 312). For example, a threshold is applied to the score outputted by the machine learning model for a user-job pair, and a recommendation of the job to the user (or the user as a candidate for the job) is generated if the score meets or exceeds the threshold. In another example, a ranking of jobs for a given user is generated by descending score from the machine learning model, and a highest-ranked portion of jobs in the ranking is outputted as job recommendations to the user. In a third example, scores generated by the machine learning model for a set of users and a given job are used to filter and/or sort the users by likelihood of positive outcome before the users are displayed to a recruiter, hiring manager, or other moderator or poster of the job.

Operation 302 can also be repeated on a periodic basis and/or based on the availability of new features and/or outcomes for the users and entities. For example, the tree-based model can be trained after new features are added and/or generated for the users and/or entities and/or after a threshold number of new outcomes have been collected for user-entity pairs.

Versions of the machine learning model used to score user-entity pairs in operation 306 can be trained on the same schedule as the tree-based model and/or separately from the tree-based model. For example, the global, user-specific, and/or job-specific versions of the machine learning model can be trained regularly (e.g., daily, every week, etc.) and/or as new features, interactions, or outcomes related to the corresponding users and/or jobs become available.

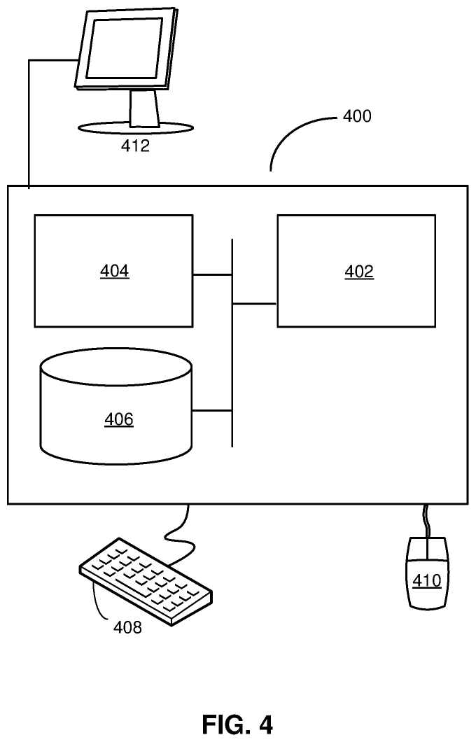

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 includes functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications obtain the use of hardware resources on computer system 400 from the operating system, as well as interact with the user through a hardware and/or software framework provided by the operating system.

In one or more embodiments, computer system 400 provides a system for processing data. The system includes a feature-processing apparatus, a model-creation apparatus, and a management apparatus. The feature-processing apparatus determines features for users and jobs (or other types of entities). The model-creation apparatus trains a tree-based model to predict the outcomes between the users and the jobs based on additional features for the users and the jobs. The model-creation apparatus also trains the machine learning model to predict one or more of the outcomes between the users and jobs based on interactions among the features identified by the tree-based model.

The management apparatus applies the tree-based model to features for a user and a job to generate a set of values representing the interactions among the features. Next, the management apparatus inputs the set of values into a machine learning model to produce a score representing a likelihood of a positive outcome between the user and job. The management apparatus then outputs a recommendation related to the user and job based on the score.

In addition, one or more components of computer system 400 may be remotely located and connected to the other components over a network. Portions of the present embodiments (e.g., feature-processing apparatus, model-creation apparatus, management apparatus, data repository, model repository, online network, etc.) may also be located on different nodes of a distributed system that implements the embodiments. For example, the present embodiments may be implemented using a cloud computing system that generates recommendations between a set of remote users and a set of entities.

By configuring privacy controls or settings as they desire, members of a social network, a professional network, or other user community that may use or interact with embodiments described herein can control or restrict the information that is collected from them, the information that is provided to them, their interactions with such information and with other members, and; or how such information is used. implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
determining, based on data retrieved from a data store in an online system, features related to a user of the online system and a job;
applying, by one or more computer systems to the features, a tree-based model that is trained based on outcomes between users and jobs to generate a set of values representing interactions among the features;
inputting, by the one or more computer systems, the set of values into a machine learning model to produce a score representing a likelihood of a positive outcome between the user and the job; and
outputting, in a user interface of the online system, a recommendation related to the user and the job based on the score.

2. The method of claim 1, further comprising:
training the tree-based model to predict the outcomes between the users and the jobs based on additional features for the users and the jobs.

3. The method of claim 2, wherein the outcomes comprise at least one of:
a dismissal of a first job; and
ignoring a second job.

4. The method of claim 1, wherein applying the tree-based model to the features for the user and the job to generate the set of values representing the interactions among the features comprises:
inputting the features into the tree-based model; and
obtaining the set of values as predictions from leaf nodes of the tree-based model.

5. The method of claim 1, wherein inputting the set of values into the machine learning model to produce the score representing the likelihood of the positive outcome between the user and the job comprises:
inputting the set of values into a global version of the machine learning model; and
combining output of the global version with additional output from one or more personalized versions of the machine learning model into the score.

6. The method of claim 5, wherein the one or more personalized versions comprise at least one of:
a user-specific version for the user; and
a job-specific version for the job.

7. The method of claim 1, wherein the positive outcome comprises at least one of:
impressions of the job by the user over multiple sessions; and
an application to the job by the user.

8. The method of claim 1, wherein outputting the recommendation related to the user and the job based on the score comprises:
generating a ranking of the job and additional jobs by scores from the machine learning model; and
outputting at least a portion of the ranking as job recommendations to the user.

9. The method of claim 1, wherein the features comprise:
user features produced from user attributes of the user;
job features produced from job attributes for the job; and
user-job features comprising comparisons of the user features and the job features.

10. The method of claim 9, wherein the comparisons of the user features and the job features comprise at least one of:
a cosine similarity;
a Hadamard product; and
a cross product.

11. The method of claim 9, wherein the user attributes and the job attributes comprise at least one of:
a title;
a seniority;
an industry;
a current function;
a past function;
a language;
a company size;
a degree;
a field of study;
a skill; and
a location.

12. The method of claim 1, wherein the tree-based model comprises a gradient boosted tree.

13. A system, comprising:
one or more processors; and
memory storing instructions that, when executed by the one or more processors, cause the system to:
determine, based on data retrieved from a data store in an online system, features related to a user of the online system and an entity, wherein the features comprise user features produced from user attributes of the user, entity features produced from entity attributes for the entity, and user-entity features comprising comparisons of the user features and the entity features;
apply, to the features, a tree-based model that is trained based on outcomes between users and entities to generate a set of values representing interactions among the features;
input the set of values into a machine learning model to produce a score representing a likelihood of an outcome between the user and the entity; and
output, in a user interface of the online system, a recommendation related to the user and the entity based on the score.

14. The system of claim 13, wherein the memory further stores instructions that, when executed by the one or more processors, cause the system to:
train the tree-based model to predict the outcomes between the users and the entities based on additional features for the users and the entities; and
train the machine learning model to predict one or more of the outcomes between the users and the entities based on the interactions among the features.

15. The system of claim 13, wherein applying the tree-based model to the features for the user and the job to generate the set of values representing the interactions among the features comprises:
inputting the features into the tree-based model; and
obtaining the set of values as predictions from leaf nodes of the tree-based model.

16. The system of claim 13, wherein inputting the set of values into the machine learning model to produce the score representing the likelihood of the outcome between the user and the entity comprises:
inputting the set of values into a global version of the machine learning model; and
combining output of the global version with additional output from one or more personalized versions of the machine learning model into the score.

17. The system of claim 13, wherein:
the entity comprises a job; and
the outcome comprises at least one of impressions of the job by the user over multiple sessions and an application to the job by the user.

18. The system of claim 17, wherein the user features and the entity features comprise at least one of:
a title;
a seniority;
an industry;
a current function;
a past function;
a language;
a company size;
a degree;
a field of study;
a skill; and
a location.

19. The system of claim 13, wherein the tree-based model comprises a gradient boosted tree.

20. A non-transitory computer-readable storage medium storing instructions that when executed by a computer cause the computer to perform a method, the method comprising:
determining, based on data retrieved from a data store in an online system, features related to a user of the online system and a job;
applying, by one or more computer systems to the features, a tree-based model that is trained based on outcomes between users and jobs to generate a set of values representing interactions among the features;
inputting, by the one or more computer systems, the set of values into a machine learning model to produce a score representing a likelihood of a positive outcome between the user and the job; and
outputting, in a user interface of the online system, a recommendation related to the user and the job based on the score.
